(19) United States
(12) Patent Application Publication
(10) Pub. No.: US 2026/0098808 A1
(43) Pub. Date: Apr. 9, 2026

(54) Device for Providing Excitation Light for Analyzing a Biological Sample by Means of Fluorescence Measurement and Method for Operating Such a Device

(71) Applicant: Robert Bosch GmbH, Stuttgart (DE)

(72) Inventors: Ingo Ramsteiner, Ettlingen (DE); Jan Mueller, Eningen Unter Achalm (DE)

(21) Appl. No.: 19/352,006

(22) Filed: Oct. 7, 2025

(30) Foreign Application Priority Data
Oct. 8, 2024 (DE) 10 2024 209 780.2

(51) Int. Cl. G01N 21/64

(52) U.S. Cl. CPC G01N 21/645; G01N 21/6428; G01N 2021/6471; G01N 2201/06193

(57) ABSTRACT

A device for providing excitation light for analyzing a biological sample by way of fluorescence measurement is disclosed. The device includes a light emission unit configured to selectively emit first emission light via a first beam path or second emission light via a second beam path. The device also includes a filter unit designed to filter the first emission light and the second emission light in order to transmit different excitation bands of the emission light to generate the excitation light. The filter unit includes a plurality of interference filters for the excitation bands and a filter changing device to which the interference filters are attached. The filter changing device is designed to move the interference filters together and to arrange one of the interference filters in each beam path. The device further includes a deflection unit configured to combine the beam paths and direct them to an output of the device for outputting the excitation light. The deflection unit is arranged in the beam paths between the filter unit and the output.

This application claims priority under 35 U.S.C. § 119 to application no. DE 10 2024 209 780.2, filed on Oct. 8, 2024 in Germany, the disclosure of which is incorporated herein by reference in its entirety.

### BACKGROUND

The disclosure is based on a device or a method according to the description below. The subject matter of the present disclosure is also a computer program.

In the life sciences in particular, numerous experimental methods, such as fluorescence microscopy, flow cytometry, quantitative PCR, histopathology and the like, are based on fluorescence phenomena. A light source can be particularly important for the relevant instruments, as fluorescence measurement requires excitation of the sample with precisely defined wavelength bands, usually with a high spectral density. The light source should be able to switch between these excitation bands.

Conventionally, such light sources can be implemented, for example, by 1) providing a very broadband light source, e.g., a white LED, incandescent or gas discharge lamp, with interchangeable dielectric bandpass filters arranged, for example, on a slider or wheel, or 2) using several light sources that a) have intrinsically limited spectral ranges (lasers, SLDs) and/or b) are more broadband (e.g., colored LEDs), but are spectrally defined by a fixed bandpass filter in each case.

Approach 1) in particular requires a light source with a spectrum broad enough to cover all the required wavelength bands. This in itself can be difficult, as commercially available white LEDs or remote phosphor sources, for example, only appear white to the eye, but actually have a deep gap in the spectrum between 450 and 500 nm due to their principle and can also be very weak in the red range >650 nm. A lot of light may be wasted here because in each channel only one band, for example 20 nm wide, is cut out of a spectrum that is at least 20 times wider, e.g. 400-800 nm, and the remaining light, for example 90% or more, has to be blocked by a high-quality bandpass filter and the correspondingly dimensioned source causes waste heat. Approach 2a) uses comparatively cost-intensive sources and also requires dichroic unifiers. Approach 2b) can often be technically complex because a separate source with associated electronics must be provided for each channel. In order to combine the beam paths of the individual channels towards the sample, a dichroic filter is also required for each channel after the first, the installation position of which can be subject to very narrow tolerances, which can require increased adjustment effort.

### SUMMARY

Against this background, the approach presented here introduces a device for providing excitation light for analyzing a biological sample by way of fluorescence measurement, a method for operating such a device, a control device that uses this method, and finally a corresponding computer program in accordance with the description below. The measures listed in the description below enable advantageous further developments and improvements to the specified device.

According to embodiments, a device can be used in particular to provide excitation light for analyzing a biological sample by way of fluorescence measurement, which device can guide light emitted by a light source unit via two beam paths, each with different, mechanically interchangeable interference filters, wherein a common mechanical actuator can be used to change the filters in both beam paths simultaneously. Against the background of the aforementioned prior art, this can also be understood as a hybrid approach for such a device.

A device for providing excitation light for analyzing a biological sample by way of fluorescence measurement is presented, wherein the device has the following features:
a light emission unit configured to selectively emit first emission light via a first beam path or second emission light via a second beam path, wherein the first beam path and the second beam path run at least partially separate from one another;
a filter unit designed to filter the first emission light and the second emission light in order to transmit different predefined excitation bands of the respective emission light to generate the excitation light, wherein the filter unit has a plurality of filters, interference filters for the different excitation bands and a filter changing device to which the filters, in particular interference filters, are attached, wherein the filter changing device is designed to move the filters, interference filters, together and to arrange one of the filters, in particular interference filters, in each beam path; and a deflection unit which is designed to combine the beam paths and direct them to an output of the device for emitting the excitation light, wherein the deflection unit is arranged in the beam paths between the filter unit and the output.

In other words, the filter unit is designed to transmit the first emission light and the second emission light in the wavelength range in which the phosphorescent material can be excited.

The filter changing device can be designed as a slide or a wheel. The filters or interference filters can be designed as bandpass filters in particular. The device may also include collimating optics for each beam path to parallelize the respective beam of emission light before it passes through the filter unit.

According to one embodiment, the filter changing device can be movable between a first position and a second position and can be designed to arrange a first filter or first interference filter in the first beam path and a third filter or third interference filter in the second beam path in the first position, and to arrange a second filter or second interference filter in the first beam path and a fourth filter or fourth interference filter in the second beam path in the second position. Thus, the filter changing device can comprise four interference filters. Such an embodiment offers the advantage that the excitation light can be provided with four channels in a simple, cost-effective and reliable manner.

Here, the first position and the second position can be stop positions of a movement path of the filter changing device. Such an embodiment offers the advantage that, by moving the filter changing device only from one stop position to the other, a structurally simple option for changing the filter can be implemented. In particular, this eliminates the need for a position sensor. In addition or alternatively, the filter changing device can be driven electromagnetically or by way of a shape-memory alloy. Such an embodiment offers the advantage that the filter change can be carried out simply and safely by way of a single drive unit.

The filter changing device can also be movable to at least one intermediate position between the first position and the second position and can be designed to arrange a further filter or interference filter in the first beam path and an additional filter or interference filter in the second beam path in the intermediate position. Such an embodiment offers the advantage that more channels of excitation light can be provided if required.

Furthermore, the light emission unit can be designed to emit the first emission light with a first spectrum and the second emission light with a second spectrum. In this case, the first spectrum and the second spectrum can differ at least partially from each other. Such an embodiment offers the advantage that optimized spectra can be generated for different channels of the excitation light, while still allowing the use of cost-effective components for the light emission unit.

According to one embodiment, the light emission unit may comprise a first light source for emitting the first emission light and a second light source for emitting the second emission light. The light sources may be implemented as light-emitting diodes, superluminescent diodes, or gas discharge lamps. Alternatively, the light sources may be implemented as remote phosphor sources, each having a laser source and a phosphor. Such an embodiment offers the advantage that the first and second emission lights can be generated in a reliable and structurally simple manner.

According to another embodiment, the light emission unit may comprise a remote phosphor source with a laser source, a first phosphor, and a second phosphor. Here, the laser source may be switchable to selectively excite the first phosphor to emit the first emission light or excite the second phosphor to emit the second emission light. The switching can be achieved by deflecting the laser beam, for example with a micromechanical mirror, by blocking and releasing a respective partial beam, for example with a mechanical shutter, or by a fiber optic arrangement. Such an embodiment offers the advantage that only one light source is required.

For example, the phosphors may comprise cerium-doped lutetium aluminum garnet, cerium-doped gadolinium garnet, gadolinium-substituted yttrium aluminum garnet, and/or cerium-doped yttrium aluminum garnet. The proportion of cerium doping may be variable. In addition or alternatively, yttrium can be partially or completely substituted by other rare earths. In addition or alternatively, aluminum can be substituted by other elements. In this way, the emission bands of the phosphor can be advantageously and precisely adjusted to a specific application.

The deflection unit can also have a first deflection device and a second deflection device. The first deflection device can comprise a mirror, whereby the second deflection device can comprise a dichroic mirror or an edge filter. In this way, an advantageous combination of the beam paths towards the common output of the device can be achieved. The device can therefore also be described as a hybrid excitation optic with filter change and dichroic mirror, for example.

A method for operating an embodiment of a device presented herein is also presented, wherein the method comprises the following steps:
controlling the light emission unit to selectively emit the first emission light or the second emission light; and
operating the filter changing device of the filter unit to generate the excitation light by way of one of the filters or interference filters.

The method can thus be performed to operate a device for providing excitation light for analyzing a biological sample by way of fluorescence measurement. Thus, by performing the method, excitation light can also be provided for analyzing a biological sample by way of fluorescence measurement.

For example, this method can be implemented in software or hardware, or in a mixed form of software and hardware, for example in a control device.

The approach presented here also creates a control device which is designed to carry out, control or implement the steps of a variant of a method presented here in corresponding devices. This embodiment of the disclosure in the form of a control device can also solve the problem underlying the disclosure quickly and efficiently.

For this purpose, the control device can feature at least one computing unit for processing signals or data, at least one memory unit for storing signals or data, at least one interface to a sensor or an actuator for reading in sensor signals from the sensor or for emitting control signals to the actuator, and/or at least one communication interface for reading in or emitting data embedded in a communication protocol. The computing unit may, for example, be a signal processor, a microcontroller or the like, wherein the memory unit may be a flash memory, or a magnetic memory unit. The communication interface can be designed to read in or emit data in a wireless and/or wired manner, wherein a communication interface capable of reading in or emitting wired data can read in said data from a corresponding data transmission line, for example electrically or optically, or emit said data to a corresponding data transmission line.

In this context, the term “control device” can be understood to mean an electrical device that processes sensor signals and emits control signals and/or data signals as a function thereof. The control device can feature an interface, which can be designed as hardware and/or software. For example, given a hardware design, the interfaces can be part of what is referred to as an ASIC system, which contains a wide variety of functions for the control device. However, it is also possible that the interfaces are dedicated integrated circuits or consist at least partly of discrete components. When implemented as software, the interfaces may be software modules present, for example, on a microcontroller alongside other software modules.

An analysis device for analyzing a biological sample is also presented, wherein the analysis device comprises an embodiment of a device mentioned herein for providing excitation light for analyzing a biological sample by way of fluorescence measurement. The analysis device is designed to analyze a biological sample by way of fluorescence measurement using the excitation light provided by the device. Optionally, the analysis device additionally comprises an embodiment of a control device mentioned herein. In this case, the control device can be connected to the light source unit and the filter changing device in a manner capable of signal transmission.

Also advantageous is a computer program product or computer program with program code which can be stored on a machine-readable carrier or storage medium, e.g., a semi-conductor memory, a hard disk memory, or an optical memory and which is used to perform, implement and/or control the steps of the method according to one of the embodiments described above, in particular if the program product or program is executed on a computer or a device.

### BRIEF DESCRIPTION OF THE DRAWINGS

Embodiment examples of the approach presented here are shown in the drawings and explained in greater detail in the following description. The figure shows:

FIG. 1 a schematic illustration of an exemplary embodiment of a device for providing excitation light for analyzing a biological sample by way of fluorescence measurement;

FIG. 2 a schematic illustration of switching states and spectra of the device from FIG. 1; and

FIG. 3 a flowchart of an exemplary embodiment of a method for operating a device for providing excitation light for analyzing a biological sample by way of fluorescence measurement.

### DETAILED DESCRIPTION

In the following description of advantageous embodiment examples of the present disclosure, identical or similar reference numbers are used for elements shown in the various drawings which have a similar function, wherein a repeated description of these elements has been omitted.

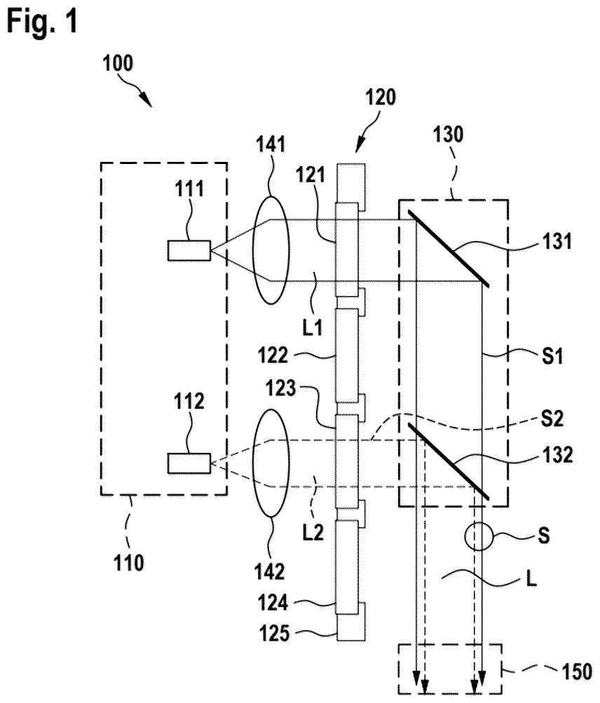

FIG. 1 shows a schematic illustration of an exemplary embodiment of a device 100 for providing excitation light L for analyzing a biological sample by way of fluorescence measurement. The device 100 is intended for use in an analyzer for analyzing the biological sample by way of fluorescence measurement. The device 100 can also be referred to as a device for providing excitation light. The device 100 comprises a light emission unit 110, a filter unit 120, and a deflection unit 130.

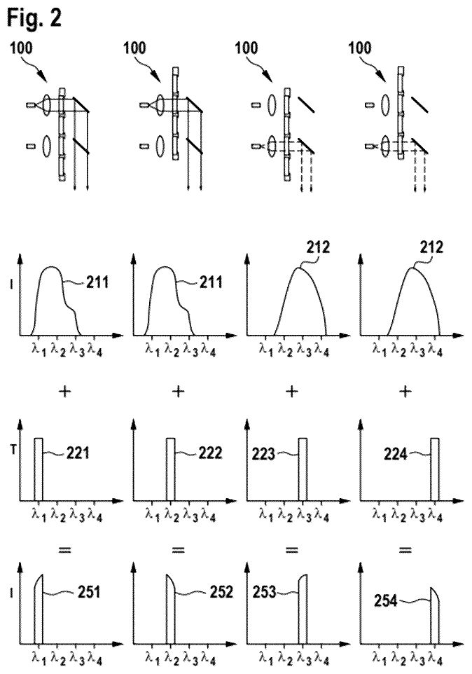

The light emission unit 110 is designed to selectively emit first emission light L1 via a first beam path S1 or second emission light L2 via a second beam path S2. The first beam path S1 and the second beam path S2 run at least partially separate from each other. According to one exemplary embodiment, the light emission unit 10 is designed to emit the first emission light L1 with a first spectrum and the second emission light L2 with a second spectrum, wherein the first spectrum and the second spectrum differ at least partially from each other, see also FIG. 2.

According to the exemplary embodiment shown here, the light emission unit 110 comprises a first light source 111 for emitting the first emission light L1 and a second light source 112 for emitting the second emission light L2. The light sources 111 and 112 are designed, for example, as light-emitting diodes, superluminescent diodes, or gas discharge lamps, or alternatively as remote phosphor sources, each having a laser source and a phosphor. According to another exemplary embodiment, the light emission unit 110 comprises a remote phosphor source with a laser source, a first phosphor, and a second phosphor. The laser source is switchable to selectively excite the first phosphor to emit the first emission light L1 or to excite the second phosphor to emit the second emission light L2.r.

The filter unit 120 is designed to filter the first emission light L1 and the second emission light L2 in order to transmit different predefined excitation bands of the emission light L1, L2 to generate the excitation light L. The filter unit 120 comprises a plurality of interference filters 121, 122, 123, 124 for the different excitation bands and a filter changing device 125 to which the interference filters 121, 122, 123, 124 are attached. The filter changing device 125 is designed to move the interference filters 121, 122, 123, 124 together. In addition, the filter changing device 125 is designed to arrange one of the interference filters 121, 122, 123, 124 in each beam path S1 and S2. The interference filters 121, 122, 123, 124 are designed, for example, as bandpass filters.

According to the exemplary embodiment shown here, the filter changing device 125 of the filter unit 120 is movable between a first position and a second position. The filter changing device 125 is designed to arrange a first interference filter 121 in the first beam path S1 and a third interference filter 123 in the second beam path S2 in the first position. Furthermore, the filter changing device 125 is designed to arrange a second interference filter 122 in the first beam path S1 and a fourth interference filter 124 in the second beam path S2 in the second position. The first position is shown in the illustration in FIG. 1. According to an exemplary embodiment, the first position and the second position are stop positions of a movement path of the filter changing device 125. In addition or as an alternative, the filter changing device 125 is driven electromagnetically or by way of a shape-memory alloy. According to a further exemplary embodiment, the filter changing device 125 is movable to at least one intermediate position between the first position and the second position. In this case, the filter changing device 125 is designed to arrange a further interference filter for a further excitation band in the first beam path S1 and an additional interference filter for an additional excitation band in the second beam path S2 in the intermediate position.

The deflection unit 130 is designed to combine the beam paths S1 and S2 and direct them to an output 150 of the device 100 for emitting the excitation light L. Thus, the deflection unit 130 is designed to combine the beam paths S1 and S2 into a common beam path S. The deflection unit 130 is arranged in the beam paths S1 and S2 between the filter unit 120 and the output 150. In other words, the filter unit 120 is arranged between the light emission unit 110 and the deflection unit 130.

According to the exemplary embodiment shown here, the deflection unit 130 comprises a first deflection device 131 and a second deflection device 132. The first deflection device 131 comprises a mirror, and the second deflection device 132 comprises a dichroic mirror or an edge filter.

Furthermore, according to the exemplary embodiment shown here, the device 100 optionally also comprises a first collimating optic 141 for parallelizing the first emission light L1 before it passes through the filter unit 120 and a second collimating optic 142 for parallelizing the second emission light L2 before it passes through the filter unit 120. The first collimating optics 141 and the second collimating optics 142 are arranged in the respective beam paths S1 and S2 between the light emission unit 110 and the filter unit 120.

The first beam path S1 runs from the first light source 111, through the optional first collimation optics 141 and through the filter unit 120, here, due to the position of the filter unit 120 or its filter changing device 125, the first interference filter 121, and is deflected at the deflection unit 130, more precisely at the first deflection device 131 designed as a mirror, then passes through the second deflection device 132 designed as a dichroic mirror or edge filter, and then runs along the common beam path S or forms part of it. and then travels along the common beam path S or forms part of it. The second beam path S2 runs from the second light source 112, through the optional second collimating optics 142 and through the filter unit 120, here, due to the position of the filter unit 120 or its filter changing device 125, the third interference filter 123, and is deflected at the deflection unit 130, more precisely at the second deflection device 132, which is designed as a dichroic mirror or edge filter, then runs along the common beam path S or forms part of it.

In other words, the exemplary embodiment of device 100 shown in FIG. 1 is suitable for the common case where four excitation bands are required. The four bands are, for example, at 470 nm, 530 nm, 580 nm, and 640 nm and are each 20 nm wide or have such a full width at half maximum (FWHM). The device 100 is based in particular on a hybrid approach in which two light sources 111 and 112 are each provided with two different, mechanically interchangeable bandpass filters 121 and 122 as well as 123 and 124. Preferably, a common mechanical actuator is used with the filter changing device 125 to change the filters simultaneously in both beam paths S1 and S2. The mechanical filter changer preferably has two positions, which is mechanically easier to implement than three or more, since, for example, no stepper motor and no position sensor are required. It is technically easier to switch between two stop positions. The use of two light sources 111 and 112 represents an advantageous compromise between one source and four sources. One source would have to be very broadband, at least 200 nm in the wavelength example mentioned above, and would therefore have a relatively low spectral density in the actually relevant spectral ranges. Specifically, this would mean that even a spectrally homogeneous source with a width of exactly 200 nm would only emit 10% of its intensity in a 20 nm wide band. 90% would have to be blocked by a very high-quality bandpass filter and would be lost as waste heat. Since the spectrum of real sources is rarely homogeneous and cannot be adjusted to freely selectable widths, the actual conditions could be even less favorable. Four sources, on the other hand, would require more components in the region of passive optics, such as lenses, beam splitters, etc., and electronics, such as regulated power supply, control, etc.

The light sources 111 and 112 are characterized by broad spectra in the sense that their spectrum covers one or more of the desired channels. For example, two identical sources can be used, each covering all four channels, but it is even more advantageous if the spectrum of one of the two light sources 111 and 112 is particularly intense in the regions of the two short-wave channels (e.g., 470 and 530 nm) and the spectrum of the other of the two light sources 111 and 112 is particularly intense in the regions of the two long-wave channels (e.g., 580 nm and 640 nm). Advantageously, the light sources 111 and 112 may be light emitting diodes (LEDs), superluminescent diodes (SLDs), gas discharge lamps or remote phosphor sources.

Remote phosphor sources are arrangements in which a laser excites a phosphor and thus realizes an incoherent, broadband source with very high luminance. Their spectrum is determined by the phosphor used. Specifically, a cerium-doped lutetium aluminum garnet (LuAG:Ce), molecular formula Lu₃Al₅O₁₂:Ce1% can be used, for the two long-wavelength channels a cerium-doped gadolinium garnet (GdAG:Ce), molecular formula GdAG:Ce2% or gadolinium-substituted yttrium aluminum garnet, molecular formula (Gd, Y)₃Al₅O₁₂:Ce2%. In principle, cerium-doped yttrium aluminum garnet (YAG:Ce), molecular formula Y₃Al₅O₁₂:Ce, which is a commercially readily available standard phosphor, can also be used for either or both sources. wavelength ranges with possibly insufficient emissions, the fluorescence of the phosphor can be mixed with the exciting laser light. The skilled person is aware of other options that are chemically similar to the phosphor examples mentioned. In particular, it is possible to change the emission band of the phosphor based on the well-known YAG:Ce by varying the cerium doping, partially or completely substituting yttrium with other rare earths, or substituting aluminum with other elements. Alternatively, the two light sources 111 and 112 can also be realized in such a way that two phosphors are used, which are excited by a common laser source. Switching is then performed by deflecting the beam, e.g., with a micromechanical mirror, by blocking/releasing a partial beam, e.g., with a mechanical shutter, or by way of a fiber optic arrangement (switch).

The collimation optics 141 and 142, indicated in FIG. 1 by a lens in each case, are used to parallelize the beam before it passes through the respective bandpass filter 121 or 122 and 123 or 124. This is usually advantageous because bandpass filters only work well in a narrow angle range, but is optional for the device 100. There may be configurations in which collimation can be dispensed with, e.g. because the source already emits collimated light or the divergence and its consequences can simply be accepted. Otherwise, collimation in front of the filter can be realized using ways such as refractive lenses, Fresnel lenses, etc.

The filter changer or the filter changing device 125 is a mechanical element with two positions, which are characterized in that in each position one of two filter pairs 121 and 123 or 122 and 124 is placed in the two beam paths S1 and S2. The filter changing device 125 may be a slider or a wheel, for example, which is driven electromagnetically or by way of a shape memory alloy. It is advantageous if the two positions are stop positions from a mechanical point of view, i.e. there is no need for a position sensor.

The bandpass filters 121, 122, 123, 124 are advantageously dielectric interference filters. They are designed to transmit light in the area of the desired excitation band, preferably >90%, but reflect light outside this band with a particularly high optical density, OD>4, on the immediate long-wave side of the band.

A dichroic mirror or edge filter as a second deflection device 132 serves to combine the two beam paths S1 and S2. It is designed to reflect light above a certain wavelength and transmit light below (short-pass filter). Alternatively, it can be set up in reverse to transmit long-wave light and reflect short-wave light (long-pass filter). Which variant is used depends on which of the light sources 111 and 112 is to provide the short-wave channels and which is to provide the long-wave channels. In the arrangement shown in FIG. 1, a short pass must be used if the first light source 111 supplies the short-wave channels. It then transmits the light of the short-wave channels, while the long-wave channels of the second light source 112 are reflected.

FIG. 2 is a schematic illustration of switching states and spectra of the device 100 of FIG. 1. In this illustration, a total of four columns show four switching states of the device 100 together with the associated spectra.

The first column shows a first switching state of the device 100. In the first switching state, the first light source is used to generate the first emission light, and the filter unit is arranged in the first position, in which the first interference filter is arranged in the first beam path to filter the first emission light. Furthermore, a first spectrum 211 of the first light source is schematically plotted as intensity I over wavelengths λ, whereby characteristic wavelengths λ₁, λ₂, λ₃, λ₄ of four excitation bands are also drawn in, which can only be at 470 nm, 530 nm, 580 nm and 640 nm as examples. In addition, a passband 221 of the first interference filter or bandpass filter is plotted as a transmittance T over wavelengths λ, wherein the wavelength passing through the passband 221 is at a first wavelength λ₁. Finally, a first excitation band 251 is also plotted as a result of filtering the first spectrum 211 with the transmission band 221 as intensity I over wavelengths λ.

A second column shows a second switching state of the device 100. In the second switching state, the first light source is used to generate the first emission light, and the filter unit is arranged in the second position, in which the second interference filter is arranged in the first beam path to filter the first emission light. Furthermore, the first spectrum 211 of the first light source is again schematically plotted as intensity I over wavelengths λ, whereby the characteristic wavelengths λ₁, λ₂, λ₃, λ₄ of the four excitation bands are also shown, which can only be at 470 nm, 530 nm, 580 nm and 640 nm as examples. In addition, a passband 222 of the second interference filter or bandpass filter is plotted as transmittance T over wavelengths λ, wherein the passband 222 lies at a second wavelength λ2. Finally, a second excitation band 252 is also plotted as a result of filtering the first spectrum 211 with the transmission band 222 as intensity I over wavelengths λ.

A third switching state of the device 100 is shown in a third column. In the third switching state, the second light source is used to generate the second emission light, and the filter unit is arranged in the first position, in which the third interference filter is arranged in the second beam path to filter the second emission light. Furthermore, a second spectrum 212 of the second light source is schematically plotted as intensity I over wavelengths λ, wherein the characteristic wavelengths λ₁, λ₂, λ₃, λ₄ of the four excitation bands are also shown, which can be merely exemplary at 470 nm, 530 nm, 580 nm and 640 nm. In addition, a passband 223 of the third interference filter or bandpass filter is plotted as a transmittance T over wavelengths λ, wherein the wavelength passing through the passband 223 is at a third wavelength λ₃. Finally, a third excitation band 253 is also plotted as a result of filtering the second spectrum 212 with the transmission band 223 as intensity I over wavelengths λ.

A fourth switching state of the device 100 is shown in a fourth column. In the fourth switching state, the second light source is used to generate the second emission light, and the filter unit is arranged in the second position, in which the fourth interference filter is arranged in the second beam path to filter the second emission light. Furthermore, the second spectrum 212 of the second light source is again schematically plotted as intensity I over wavelengths λ, whereby the characteristic wavelengths λ₁, λ₂, λ₃, λ₄ of the four excitation bands are also drawn in, which can only be at 470 nm, 530 nm, 580 nm and 640 nm by way of example. In addition, a passband 224 of the fourth interference filter or bandpass filter is plotted as a transmittance T over wavelengths λ, wherein the wavelength passing through the passband 224 is at a fourth wavelength λ₄. Finally, a fourth excitation band 254 is also plotted as a result of filtering the second spectrum 212 with the passband 224 as intensity I over wavelengths λ.

In other words, the two individually activatable light sources and two filter positions or positions of the filter unit allow the realization of four excitation channels 251, 252, 253, and 254. In other words, individual switching between the two light sources and two filter positions allows the realization of four excitation channels. The first line of the display shows the thematic configurations or switching states, the second line shows the spectra of the currently active light source, the third line shows the spectra of the bandpass filter in the currently active beam path, and the fourth line shows the spectrum emitted by the device 100, which is created by filtering the currently active light source with the associated bandpass filter.

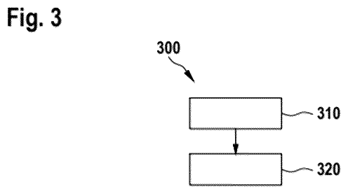

FIG. 3 shows a flowchart of an exemplary embodiment of a method 300 for operating a device for providing excitation light for analyzing a biological sample by way of fluorescence measurement. The method 300 for operation is executable to operate the device from one of the figures described herein. Thus, the method 300 can be performed in conjunction with the device shown in one of the figures described herein.

The method 300 for operating comprises a step 310 of driving the light emission unit to selectively emit the first emission light or the second emission light. Furthermore, the method 300 for operation comprises a step 320 of actuating the filter changing device of the filter unit in order to generate the excitation light by way of one of the interference filters.

If an exemplary embodiment comprises an “and/or” conjunction between a first feature and a second feature, this is to be read such that the exemplary embodiment according to one embodiment comprises both the first feature and the second feature and according to a further embodiment comprises either only the first feature or only the second feature.

What is claimed is:

1. A device for providing excitation light for analyzing a biological sample by way of fluorescence measurement, the device comprising:
a light emission unit which is designed to selectively emit first emission light via a first beam path or second emission light via a second beam path, wherein the first beam path and the second beam path run at least partially separately from each other;
a filter unit configured to filter the first emission light and the second emission light to transmit different predefined excitation bands of the respective emission light to produce the excitation light, wherein the filter unit comprises a plurality interference filters for the different excitation bands and a filter changing device to which the interference filters are attached, and wherein the filter changing device is designed to move the interference filters together and to arrange one of the interference filters in each beam path; and
a deflection unit designed to combine the beam paths and direct them to an output of the device for outputting the excitation light, wherein the deflection unit is arranged in the beam paths between the filter unit and the output.

2. The device according to claim 1, wherein the filter changing device is movable between a first position and a second position and is designed to arrange a first interference filter in the first beam path and a third interference filter in the second beam path, and in the second position to arrange a second interference filter in the first beam path and a fourth interference filter in the second beam path.

3. The device according to claim 2, wherein the first position and the second position are stop positions of a movement path of the filter changing device, and/or wherein the filter changing device is actuated electromagnetically or by way of a shape-memory alloy.

4. The device according to claim 2, wherein the filter changing device is movable into at least one intermediate position between the first position and the second position and is designed to arrange an interference filter in the first beam path and an additional interference filter in the second beam path in the intermediate position.

5. The device according to claim 1, wherein the light emission unit is configured to emit the first emission light with a first spectrum and the second emission light with a second spectrum, and wherein the first spectrum and the second spectrum differ at least partially from each other.

6. The device according to claim 1, wherein the light emission unit has a first light source for emitting the first emission light and a second light source for emitting the second emission light, and wherein the light sources comprise or are designed as light-emitting diodes and/or superluminescent diodes and/or gas discharge lamps, or comprise or are designed as remote phosphor sources, each having a laser source and a phosphor.

7. The device according to claim 1, wherein the light emission unit comprises a remote phosphor source having a laser source, a first phosphor, and a second phosphor, and wherein the laser source is switchable to selectively excite the first phosphor to emit the first emission light or excite the second phosphor to emit the second emission light.

8. The device according to any claim 6, wherein the phosphors comprise cerium-doped lutetium aluminum garnet and/or cerium-doped gadolinium garnet and/or gadolinium-substituted yttrium aluminum garnet and/or cerium-doped yttrium aluminum garnet.

9. The device according to claim 1, wherein the deflection unit comprises a first deflection device and a second deflection device, and wherein the first deflection device comprises a mirror and wherein the second deflection device comprises a dichroic mirror or an edge filter.

10. A method for operating the device according to claim 1, comprising:
actuating the light emission unit to selectively emit the first emission light or the second emission light; and
operating the filter changing device of the filter unit in order to generate the excitation light by way of one of the interference filters.

11. Use of the device according to claim 1 for providing excitation light for analyzing a biological sample by way of fluorescence measurement.
